(19) United States
(12) Patent Application Publication
(10) Pub. No.: US 2020/0333218 A1
(43) Pub. Date: Oct. 22, 2020

(54) REAL-TIME VAPOUR EXTRACTING DEVICE

(71) Applicant: ANCON TECHNOLOGIES LIMITED, Kent (GB)

(72) Inventor: Boris Zachar GORBUNOV, Kent (GB)

(73) Assignee: ANCON TECHNOLOGIES LIMITED, Kent (GB)

(21) Appl. No.: 16/850,652

(22) Filed: Apr. 16, 2020

(30) Foreign Application Priority Data
Apr. 17, 2019 (GB) 1905422.0

(51) Int. Cl. G01N 1/22

(52) U.S. Cl. CPC G01N 1/2202; G01N 30/14; G01N 2001/227; G01N 1/2247

(57) ABSTRACT

The invention provides a device for extracting a vaporizable analyte from a sample gas containing the analyte and unwanted aerosol particles;
the device comprising a vapour extraction chamber (2), first (3) and second (4) inlets, and first (5) and second (6) outlets;
the vapour extraction chamber (2) being provided with or being linked to a heat source for heating the vapour extraction chamber (2) to a desired temperature to facilitate vaporization of analyte present in the sample gas;
the first (3) and second (4) inlets being linked to an upstream end of the vapour extraction chamber (2) and the first (5) and second (6) outlets being linked to a downstream end of the extraction chamber (2);
the first inlet (3) allowing a sample of gas containing the analyte and unwanted aerosol particles to be introduced into the vapour extraction chamber (2);
the second inlet (4) being connected or connectable to a clean gas supply that does not contain the analyte or unwanted aerosol particles;
the device being configured such that, in use, a sample gas flow (7) is established through the vapour extraction chamber between the first inlet (3) and the first outlet (5), and a clean gas flow (8) is established through the vapour extraction chamber between the second inlet (4) and the second outlet (6); whereby analyte in vapour form present in the sample gas flow (7) diffuses into the clean gas flow (8), but the clean gas flow (8) reaching the second outlet is substantially free of the said unwanted aerosol particles;
the first outlet (5) serving as a waste outlet for the sample gas flow, and the second outlet (6) being connected or connectable to an instrument for analysing analyte that has diffused into the clean gas flow.

### CROSS REFERENCE TO RELATED APPLICATIONS

This application claims priority to GB Application No. 1905422.0, which was filed on Apr. 17, 2019, the entire contents of which are hereby incorporated by reference herein.

### FIELD OF THE INVENTION

This invention relates to a device for extracting analyte vapours from airborne particles (aerosols) to facilitate detection and analysis of the analyte. The invention also provides a method of on-line real-time vapour extraction comprising evaporation of an analyte from solid or liquid particles in a sample gas flow and separation of the extracted vapour from non-volatile residual particles in the sample gas flow so that the extracted vapour can be analysed while in the gas phase by passing through an analytical instrument such as a mass spectrometer or ion mobility spectrometer.

### BACKGROUND OF THE INVENTION

Many Volatile Organic Compounds (VOC) in the air exist in various forms as vapours and as aerosol particles. Some VOCs are harmful to human health and it is important therefore that they should be quantified and monitored to prevent health damage. The levels of such VOCs are typically very low, e.g. at the low part-per-billion (ppb) or less. Currently, various devices are used to quantify and analyse harmful VOCs present in the air. One such device is the Ion Mobility Spectrometer (IMS), see Eiceman G. A. Ion-mobility spectrometry as a fast monitor of chemical composition. trends in analytical chemistry, 21 (2002) or U.S. Pat. No. 6,787,763B2. However, a problem with most known devices is that they tend to work only with vapour and cannot operate, or at least cannot operate reliably, when the air contains aerosols.

Aerosol filters are used to filter out aerosol particles from air samples before they enter an IMS device, but this typically causes loss of a proportion of the analyte by retention on the filter. Often, if the equilibrium vapour pressure of an analyte is low, as for Semi-Volatile Organic Compounds (SVOC), then most of the molecular mass of the SVOC is typically accumulated in airborne particles and only a small amount is present in vapour form. Many typical SVOSs are harmful for humans and animals, e.g. some aromatic hydrocarbons, polychlorinated biphenyls, di-butyl phthalate and pesticides. In order to quantify the total amounts of such compounds, those analytes that are in a particulate form will need to be extracted from aerosol particles by transferring them into the vapour state. Some typical examples of known methods and devices for doing this are described below.

In many known methods, aerosol particles are first collected from the air onto a filter. In order to extract analyte from the particles deposited on the filters, the particulate matter deposit is heated and evaporated analyte is directed to a vapour measuring device. For example, U.S. Pat. No. 5,854,431 discloses an apparatus and method for pre-concentrating particles and vapours. The pre-concentrator apparatus permits detection of highly diluted amounts of particles in a main gas stream, such as a stream of ambient air. A main gas stream having airborne particles entrained therein is passed through a screen and the particles accumulate on the screen which acts as a type of selective particle filter. A cross-flow of clean gas past the filter is then used to displace the particles from the filter (which can be heated to facilitate displacement of the particles) and the clean gas stream containing the particles displaced from the screen can then be directed to a particle analyser. Thus, in this method, small amounts of particles are collected from large volumes of air by the screen and are then displaced from the screen into a much smaller volume of gas, and hence are concentrated before they are passed through the analyser.

A disadvantage of the method described in U.S. Pat. No. 5,854,431 and similar methods is that filters or screens can become clogged by some atmospheric particles that are very difficult subsequently to dislodge or evaporate, for example oxide particles of Al, Fe or Si. There are many metal oxides and carbonaceous particles in the atmosphere, both of natural and manmade origin. In some challenging environments metal oxides and diesel engine exhaust particles quickly deposit a thick layer of dust on the filter which prevents normal operation of a vapour analysing device.

US2008/206106 (Fernandez de la Mora) discloses a method for rapidly concentrating particles of explosive which relies upon the inertias of the particles. This concentration method is similar to the methods of particle concentration used in in virtual impactors. Concentrated particles entrained in a gas flow are directed to a heating device where they are heated to evaporate an analyte of interest so that the analyte vapour can be analysed in an analytical instrument.

There are many devices that have been designed and used for releasing VOCs and SVOCs from aerosol particles to quantify analytes present in the air in the vapour and the particulate phase (see for example: U.S. Pat. No. 6,523,393B1, U.S. Pat. No. 5,083,019A, WO2008074981A1), but such known devices have not hitherto adequately addressed the issues of clogged filters, damage to analytical instruments and the need for an in-line real-time operation. The drawbacks associated with known types of instrument are summarised in Table 1 below.

| | | Issues | | |
|---|---|---|---|---|
| | | On- | | Damaging |
| Group | Description of the method | line | Clogging | instrument |
| 1 | Deposition of particles onto solid | No | Yes | No |
| | surfaces by inertial forces with | | | |
| | subsequent evaporation of analytes | | | |
| 2 | Deposition of particles onto an | No | Yes | No |
| | aerosol filter with subsequent | | | |
| | evaporation of analytes | | | |
| 3 | Virtual impaction concentration with | Yes | No | Yes |
| | real-time heating of the air sample | | | |
| 4 | Virtual impaction concentration with | Yes | Yes | No |
| | real-time heating of the air sample | | | |
| | and filtering non-volatile particles | | | |

For example, devices in the first group require deposition of aerosol particles on a solid substrate by impaction, followed by heating the particulate matter to evaporate the analyte. After evaporation, the analyte is quantified with an ion mobility spectrometer (IMS) or mass spectrometer (MS). However, the time taken for the cycle of deposition of aerosol particles and evaporation is longer than the time of analysis with an IMS or MS device. Therefore, this method is not a real-time (on-line) method.

Also, it is well known that the solid substrates in cascade impactors often become clogged with particles to such an extent that the performance of the impactor is reduced or even that the flow of sample gas through it is severely hindered or stopped.

Devices based upon the deposition of particles onto an aerosol filter by a diffusion mechanism followed by evaporation of analytes from the particulate matter have the same drawbacks as inertial devices.

Although devices based on the virtual impactor principle can successfully address the real-time issue and can in principle operate as fast as IMS devices, the absence of a filter means that damage to the analytical instrument can occur. Introducing a filter into a virtual impactor device would address the problem of damage to the instrument caused by unfiltered particles, but then problems would arise because of filter clogging. Thus, existing devices suffer from problems associated with either filter clogging, damage to analytical instruments caused by unfiltered particles, or delays in analysis.

### The Invention

The present invention sets out to overcome or at least substantially reduce the incidence of the problems identified above by using a combination of two preferably laminar gas flows that are in close proximity to each other to facilitate heat and mass exchange. The two gas flows run together in a real-time vapour extracting chamber forming a non-uniform combined flow. One gas flow entering a vapour extracting chamber is a sample gas flow containing molecules of interest (analyte), typically in two phases: the vapour phase and as particles. This gas flow also contains atmospheric aerosol particles not related to analytes present in the air. The other gas flow entering the vapour extracting chamber is a clean gas flow without airborne particles and without analyte vapour. The vapour extracting chamber is equipped with a heating means that enables the sample flow to be heated and the analytes to be evaporated. The analyte vapour initially evaporates into the sample flow and then diffuses into the clean air flow. Diffusivities of molecules including molecules of the analyte are much greater than the diffusivities of atmospheric aerosol particles. The difference in diffusivity coefficients is sufficiently large that, at the outlet of the chamber, the clean gas flow is filled with volatile compounds evaporated from aerosol particles present in the sample flow. This clean gas flow laden with analytes is directed to an instrument, e.g. an IMS unit, to measure the vapour concentration of the analyte. The sample gas flow at the end of the vapour extracting chamber is depleted of the volatile compounds but contains all particles that cannot be evaporated or which it is considered to be advantageous not to evaporate. The depleted sample flow is directed to a waste outlet.

Accordingly, in a first aspect, the invention provides a device for extracting a vaporizable analyte from a sample gas containing the analyte and unwanted aerosol particles;
the device comprising a vapour extraction chamber, first and second inlets, and first and second outlets;
the vapour extraction chamber being provided with or being linked to a heat source for heating the vapour extraction chamber to a desired temperature to facilitate vaporization of analyte present in the sample gas;
the first and second inlets being linked to an upstream end of the vapour extraction chamber and the first and second outlets being linked to a downstream end of the extraction chamber;
the first inlet allowing a sample of gas containing the analyte and unwanted aerosol particles to be introduced into the vapour extraction chamber;
the second inlet being connected or connectable to a clean gas supply that does not contain the analyte or unwanted aerosol particles;
the device being configured such that, in use, a sample gas flow is established through the vapour extraction chamber between the first inlet and the first outlet, and a clean gas flow is established through the vapour extraction chamber between the second inlet and the second outlet; whereby analyte in vapour form present in the sample gas flow can diffuse into the clean gas flow but the clean gas flow reaching the second outlet is substantially free of the said unwanted aerosol particles;
the first outlet serving as a waste outlet for the sample gas flow, and the second outlet being connected or connectable to an instrument for analysing analyte that has diffused into the clean gas flow.

The device defined in the claims and statements of invention herein may be referred to variously as the “device according to the invention” or “the device of the invention” or, in some cases, as the real-time Vapour Extracting Device (VED). Unless the context indicates to the contrary, these terms are intended to be synonyms.

The term “unwanted aerosol particles” refers to aerosol particles that are either not vaporizable (e.g. metal oxide particles) or particles for which detection and/or analysis is not required.

The analyte is a substance of interest that can be vaporized. It may exist in the sample gas in vapour form, in particulate form, or as a mixture of vapour and particles. The term “particles” as used herein includes solid, semisolid and liquid particles. As the sample gas passes through the device, it is heated to bring about vaporization of analyte present in particulate form in the sample gas. The vaporized analyte (whether originally in vaporized form or evaporated from particles in the sample gas flow) diffuses into the clean gas flow, leaving unwanted aerosol particles in the sample gas flow.

The evaporation chamber and the various inlets and outlets are configured so as to encourage a combined non-uniform laminar flow of the sample gas and clean gas flows through the device, thereby avoiding or minimising mixing of the two gas flows and therefore minimising penetration of unwanted aerosol particles into the second outlet. Thus, typically the sample gas and clean gas form a pair of adjacent parallel gas flows through the device whereby mixing of the two gas flows is avoided or minimised but vaporized analyte can diffuse from the sample gas flow to the clean gas flow. In accordance with the invention, the clean gas flow reaching the second outlet is substantially free of the unwanted aerosol particles. By substantially free is meant that the concentration of unwanted aerosol particles (if present at all) in the clean gas flow reaching the second outlet is less than 1% (by number) of the concentration of unwanted aerosol particles reaching the first (i.e. waste) outlet. More usually, the concentration of unwanted aerosol particles (if present at all) in the clean gas flow reaching the second outlet is less than 0.5% (by number), and more preferably less than 0.25% (by number) of the concentration of unwanted aerosol particles reaching the first (i.e. waste) outlet.

In one embodiment, the first inlet is linked to the vapour extraction chamber via a first inlet conduit; and the second inlet is linked to the vapour extraction chamber via a second inlet conduit. In this embodiment, the first outlet may optionally be linked to the vapour extraction chamber via a first outlet conduit; and the second outlet may optionally be linked to the vapour extraction chamber via a second outlet conduit.

The vapour extraction chamber is provided with means for heating the vapour extraction chamber to a desired temperature to facilitate vaporization of analyte present in the sample gas. The heating means can be, for example, a heater (e.g. a heating element) embedded in, or in contact with, a wall of the vapour extraction chamber.

In one embodiment, the invention provides a real-time Vapour Extracting Device (VED) wherein:
the VED comprises a vapour extraction chamber having means for creating and maintaining a predefined elevated temperature in the chamber, the VED having first and second inlets linked via respective first and second inlet conduits to the vapour extraction chamber, and having first and second outlets linked by respective first and second outlet conduits to the vapour extraction chamber;
the first inlet enables a sample of gas (e.g. air) containing aerosol particles and vapours to be introduced via the first inlet conduit to the vapour extraction chamber with a flow rate Qₛₐₘₚₗₑ;
the second inlet is connected to a clean gas (e.g. clean air) supply that does not contain aerosol particles, the clean gas supply having a flow rate Q_{clean}.
the first and second inlet conduits join together at an upstream end of the main gas flow chamber;
the first outlet conduit is positioned at a downstream end of the vapour extracting chamber on a same side of the chamber as the first inlet conduit and is configured such that, without heating, aerosol particles are carried out of the evaporation chamber to the first outlet to waste at a flow rate Q_{waste};
the second outlet conduit is located at the downstream end of the vapour extraction chamber on a same side of the chamber as the first inlet conduit and is configured so as to prevent aerosol particles from entering the second outlet but to allow clean gas containing vapour to exit the second outlet at a flow rate Qᵥₐₚₒᵤᵣ;
and wherein the second outlet is connected, or connectable, to an instrument for analysis of molecules of interest in the clean gas.

The first (i.e. waste) outlet is may or may not be provided with a particle filter to remove particles prior to release into the environment. Where present, the filter can, for example, comprise or consist of a HEPA aerosol filter. The filter preferably has sufficient capacity for long-term operation, thereby avoiding the need for frequent replacement.

The first (i.e. waste) outlet may also be provided with a filter for removing any volatile compounds remaining in the sample gas stream as it passes to waste through the first outlet. In one embodiment, the filter for removing volatile compounds is located downstream of the particle filter. The filter for removing volatile compounds is typically a charcoal or activated carbon (activated black carbon) filter. Thus, in a particular embodiment, the first (i.e. waste) outlet is provided, in sequence, with a HEPA filter and an activated carbon black filter for removing volatile compounds. In another embodiment, the filter for removing volatile compounds is located upstream of the particle filter.

The clean gas supply may be introduced into the device through a flow maintenance system that provides low pulsation flows. Preventing or reducing pulses in the flow rate of the clean gas into the vapour extracting chamber assists in reducing turbulence and maintaining laminar flow of gases through the vapour extracting chamber. Thus, in one embodiment of the invention, the clean gas supply is provided by a low pulsation clean flow maintaining system to provide a clean gas (e.g. air) flow Q_{clean} to the second inlet. For example, the device may comprise a flow maintaining system which enables low pulsation flows to be generated with ΔQi/Qi<7% where ΔQi is the average magnitude of pulsations in flow i where i is Qₛₐₘₚₗₑ, Q_{clean}, Qᵥₐₚₒᵤᵣ and Q_{waste}.

In order to facilitate laminar flow through the vapour extraction chamber, the vapour extraction chamber, inlets, outlets and any associated conduits, if present, can be configured so as to maintain laminar flow of the sample gas flow and the clean gas flow though the device so that unwanted aerosol particles are preferably directed to the first outlet.

Thus, in order to facilitate laminar flow through the vapour extraction chamber, the internal surfaces of the conduits and the vapour extracting chamber can be made smooth (and for example can be polished) and manufactured to tolerances sufficient to reduce frictional drag and maintain laminar flow in the chamber and conduits.

The vapour extraction chamber is provided with or is linked to a heat source (heating means) for heating the vapour extraction chamber to a desired temperature to facilitate vapourisation of analyte present in the sample gas. For example, in one embodiment, the vapour extracting chamber is provided with means for heating the chamber up to a temperature Tₕ of 300° C.

The vapour extraction chamber and its connected conduits (where present) can each be circular, rectangular, ellipsoidal or polygonal (e.g. where the number of angles within the polygon is more than 3; for example, in the range from 4 to 20) in cross-section.

In one general embodiment, the vapour extraction chamber has a rectangular cross-section in a direction perpendicular to the gas (e.g. air) flow.

In another general embodiment, the vapour extraction chamber has a cylindrical (e.g. a circular cylindrical) shape having an internal diameter D and a length L.

In each of the foregoing aspects and embodiments of the invention, the length L of the vapour extracting chamber may be greater than a length (in cm) defined by a non-equality:

L>1.2*(Qₛₐₘₚₗₑ+Q_{clean})*(Tₐ/Tₕ)

where Qₛₐₘₚₗₑ and Q_{clean} are the gas flow rates of the sample gas flow and clean gas flow respectively, Tₐ is the ambient temperature, Tₕ is the temperature in the vapour extraction chamber (wherein both Tₐ and Tₕ are in degrees K and the flow rates are in cm³/s). This expression is based upon analysis of data obtained using the device of the invention.

In each of the foregoing aspects and embodiments of the invention where the vapour extracting chamber has a cylindrical (e.g. a circular cylindrical) shape of internal diameter D, D (in cm) may be defined by a non-equality:

D<0.5*(Qₛₐₘₚₗₑ+Q_{clean})*(Tₐ/Tₕ)

where Qₛₐₘₚₗₑ and Q_{clean} are the gas flow rates of the sample gas flow and clean gas flow respectively, Tₐ is the ambient temperature, Tₕ is the temperature in the vapour extraction chamber (wherein both Tₐ and Tₕ are in degrees K and the flow rates are in cm³/s). This expression is based upon analysis of data obtained using the device of the invention.

In one particular embodiment of the invention, the internal diameter D of the cylindrical vapour extracting chamber is less than 6 mm and greater than 0.1 mm and the length L of the vapour extraction chamber is greater than 3 cm and less than 300 cm.

In each of the foregoing aspects and embodiments of the invention, the device may comprise a pump with a pump driver and an aerosol filter to supply the clean gas (e.g. air) flow Q_{clean} to the clean flow inlet (second inlet) of the vapour extracting chamber. A filter, such as an activated black carbon filter, can also be provided to reduce or eliminate the presence of the volatile compounds of interest in the clean gas flow.

A high-capacity cyclone separator can be attached to the first inlet so as to remove large aerosol particles (or aerosol particles of a predetermined size) from sample gas (e.g. air samples) entering the device. Cyclone separators are well known and need not be described in detail here. Cyclone separators may advantageously be used in challenging environments, for example where very high concentrations of dust particles and/or diesel exhaust fumes are present in the sample gas.

The device of the invention is typically provided with a heat source that can be operated to heat the vapour extraction chamber to a temperature Tₕ of up to 700° C.

In the device of the invention, the vapour extraction chamber may be formed within a body made from a metal. In order to provide heating, one or a plurality of heating elements can be installed within the body or located outside and in thermal contact with an outer surface of the said body, with temperature controlling means and power supply enabling heating the chamber and/or the gas flows up to a temperature of Tₕ=700° C. This type of VED may be advantageous for very low volatility analytes such as compounds containing arsenic, tellurium or cadmium

The metal body of the device can be covered with a thermal insulating material, e.g. glass fibre, ceramic fibre, magnesium oxide, PTFE, polyetheretherketone (PEEK), rockwool, or an aerogel, to prevent loss of heat and thereby provide more consistent and reproducible heating.

The device of the invention is advantageously provided with a temperature controller for varying the temperature (Tₕ) within the vapour extraction chamber. It will be appreciated that the temperature of the vapour extracting chamber can control the vapour extraction process and therefore it is possible to tune Tₕ to a value at which predominantly molecules of interest can be evaporated more efficiently than other compounds. Thus, for example, where an analyte has sufficient volatility at a lower temperature, Tₕ can be set so (e.g. Tₕ=150° C.) that the analyte of interest forms a vapour whereas analytes that are of lesser interest and are less volatile are evaporated to a lesser extent.

The device according to the invention can be mains powered or battery powered or a combination of both. For example, in one embodiment of the invention, a battery (e.g. a rechargeable battery) is used to provide power to the device. When the device is a handheld device for use in the field, a battery (e.g. a rechargeable battery) may be preferred as a power source.

In each of the foregoing aspects and embodiments of the invention, the first outlet (i.e. the waste outlet) can be connected to a heat exchanger, for example a coiled metal (e.g. copper) tubing, to reduce the temperature of the waste gas emerging from the waste outlet. In one embodiment, the heat exchanger is linked at a downstream end thereof to an aerosol filter. This arrangement enables inexpensive low-temperature aerosol filters to be used.

The first (i.e. waste) outlet can be linked via one or more purification elements to the second (clean gas supply) inlet thereby enabling recycling of the waste gas flow and the formation of a closed loop that improves the stability of the system. It should be understood that the flow rates Q_{clean} and Q_{waste} may or may not be equal, in which case the individual flow rates may need to be augmented or reduced as necessary to balance the flows.

Where the waste gases are recycled back to the second (clean gas supply) inlet, one or more purification elements are provided for removing impurities (e.g. particles and/or traces of analyte) from the gas flow before it re-enters the vapour extraction chamber. The purification elements can comprise one or more filters for removing particulate matter and/or one or more filters (e.g. an activated carbon black filter) for removing traces of analytes and organic substances). A pump may be provided between the first outlet and the second inlet for recycling the waste gases. The pump is typically positioned in-line between a pair of filters. Thus, for example, a pump can be placed between a first aerosol filter connected to the first (i.e. waste gas) outlet and a second aerosol filter connected to the second (i.e. clean gas supply) inlet. An activated black carbon filter can also be located between the second aerosol filter and the second (clean gas supply) inlet to remove traces of analytes.

The configuration of the vapour extraction chamber, first and second inlets, first and second outlets, and the inlet and outlet conduits (when present) as defined above and elsewhere herein can be such that the sample gas flow and clean gas flow move along the vapour extraction chamber in a side-by-side manner. Alternatively, the configuration can be such that the clean gas flow forms a sheath around the sample gas flow. In a further alternative, the sample gas flow forms a sheath around the clean gas flow.

In one embodiment, the first and second inlets are arranged symmetrically with respect to the vapour extraction chamber, for example by virtue of being symmetrical with respect to a plane passing along the length of the vapour extraction chamber. For example, the first and second inlets may be connected by first and second inlet conduits respectively to the vapour extraction chamber and the first and second inlet conduits may be of substantially identical length. Furthermore, the first and second inlets and/or the first and second inlet conduits may be of substantially identical cross section, e.g. diameter. In the foregoing embodiment, the first and second inlet conduits may be arranged laterally (e.g. orthogonally) with respect to the vapour extraction chamber.

In another embodiment, the vapour extraction chamber, the first and second inlets, and their associated inlet conduits, and the first and second outlets, and their associated outlet conduits, are arranged in a substantially axially symmetrical configuration. In such an arrangement, the first and second inlet conduits can be arranged in a coaxial relative configuration such that the gas flow entering the vapour extraction chamber through one inlet conduit forms a sheath around the gas flow entering the other inlet conduit. The first and second outlets in such an arrangement can also be arranged in a coaxial relative configuration such that the sample gas flow and clean gas flow can be separated at the downstream end of the vapour extraction chamber with one gas flow exiting the vapour extraction chamber via an outer coaxial outlet conduit and the other gas flow exiting the vapour extraction chamber via an inner coaxial outlet conduit.

For example, the first and second inlet conduits can be arranged such that the clean gas flow entering the vapour extraction chamber through the second inlet conduit forms a cylindrical sheath around the sample gas entering the vapour extraction chamber through the first inlet conduit. In this arrangement, the first and second outlet conduits are typically arranged in a coaxial configuration such that the second outlet conduit is the radially outermost.

It will be appreciated that, in the foregoing example, the aerosol flow inlet, the vapour extracting chamber and the waste particle outlet can be formed by co-axial cylinders. The second (clean gas) inlet for the clean gas (e.g. air) flow forms a co-axial gas conduit shape around the sample flow that enables the formation of a cylindrical sheath flow around the sample gas flow in the vapour extraction chamber. This flow is a non-uniform flow with aerosol particles inside and the clean gas (e.g. air) around it. At the end of the vapour extraction chamber, the non-uniform flow is split in such a way that the non-volatile residuals of the aerosol sample flow are directed to the waste flow outlet directly (axially symmetrically) attached to the vapour extracting chamber and the clean gas (e.g. air) flow laden with evaporated analytes is directed to a second co-axial outlet conduit shape that is similar to that of the second inlet conduit. The co-axial conduit has an outlet (the second outlet) that is can be connected to a vapour measuring instrument.

It should be understood that, in another embodiment, the two inlets and two outlets can be interchanged in such a way that: (a) the sample gas flow enters the vapour extraction chamber through a co-axial first inlet conduit and the clean gas flow enters the chamber through an inlet which is aligned with a centre line extending along the vapour extraction chamber (which centre line coincides with or is close to the axial symmetry line of the chamber) and (b) the vapour outlet is also aligned with said centre line and a non-volatile particle waste outlet is connected to a co-axial second outlet conduit.

Accordingly, in another embodiment, the first and second inlet conduits are arranged such that the sample gas flow entering the vapour extraction chamber through the first inlet conduit forms a cylindrical sheath around the clean gas flow entering the vapour extraction chamber through the second inlet conduit. In this arrangement, the first and second outlet conduits are typically arranged in a coaxial configuration such that the first outlet conduit is the radially outermost.

In each of the foregoing aspects and embodiments of the invention, it can be advantageous to locate between the vapour outlet of the VED and the analytical instrument used to analyse vapour concentrations a device that eliminates the formation of new aerosol particles that might be formed due to the cooling of vapours extracted from the aerosol sample flow. Such a device may be referred to herein for convenience as an aerosol formation killer or aerosol formation killer device. It will be appreciated that the need for the aerosol formation killer device arises because of the large temperature difference between the vapour extraction chamber of the VED (e.g. Tₕ˜300° C.) and a desirable temperature (typically close to ambient temperature—Tₐ˜20° C.) for the gas flow entering the analytical device.

Accordingly, in another embodiment, the invention provides a VED as defined herein having an aerosol formation killer device connected to the second outlet thereof.

The aerosol formation killer device may comprise a conduit (the “aerosol formation killer device conduit”) within which there is a low temperature gradient that reduces supersaturation of vapours below a level required for aerosol formation. This enables the delivery of vapours to the analytical instrument at a concentration in excess of the equilibrium concentration.

In one embodiment, the aerosol formation killer comprises (or consists of) a conduit in which there is a gradual reduction in temperature from an upstream end thereof (i.e. the end attached to the VED) into which hot vapour (at a temperature ˜Tₕ) from the VED outlet passes, to a downstream end thereof (i.e. the end attached to the analytical instrument) from which gas at a cooler temperature passes into an inlet of the analytical instrument.

In another embodiment, the aerosol formation killer comprises (or consists of) a conduit (e.g. a cylindrical chamber) in which there is a substantially linear or non-linear reduction in temperature from an upstream end thereof (i.e. the end attached to the VED) into which hot vapour (at a temperature ˜Tₕ) from the VED outlet passes, to a downstream end thereof (i.e. the end attached to the analytical instrument) from which gas at a cooler temperature (for example ˜Tₐ) passes into an inlet of the analytical instrument.

The substantially linear reduction in temperature along the length of the conduit (e.g. cylindrical chamber) can, for example, be achieved by forming the conduit from a heat-conductive material such as a metal such that the conduit has a progressively reducing wall thickness from the upstream end thereof to the downstream end thereof.

The conduit can be formed from an inner tubular conduit element of substantially uniform wall thickness along its length, the inner tubular conduit element being enclosed within an outer sleeve formed from a high-temperature resistant material wherein the outer sleeve has a wall thickness that progressively decreases from an upstream end to a downstream end thereof.

Thus, for example, the aerosol formation killer device can comprise a cylindrical metal tube surrounded by a sleeve made of a high-temperature resistant material having a decreasing or increasing wall thickness from the upstream end (the side of the VED) to the downstream end (i.e. from the side of the analytical instrument).

The length of the aerosol formation killer device can, for example, be in the range from 1 cm to 300 cm.

The VED device as defined according to any of the preceding aspects or embodiments of the invention can be configured to be connected to any of a variety of analytical instruments, particular examples of which include mass spectrometers (MS), ion mobility spectrometers (IMS), ion Differential Mobility Analysers (iDMA), Field Asymmetric IMS (FAIMS) and gas chromatographs (GC). It will be appreciated that, in each case, the VED of the invention will be configured and operated such that the output from the VED is compatible with the operating flow rate, temperature and pressure of the analytical instrument used.

Accordingly, in a further aspect, the invention provides a combination of a device (VED) for extracting a vaporizable analyte from a sample gas containing the analyte and unwanted aerosol particle as defined herein and in any one of the foregoing aspects and embodiments, and an analytical instrument (such as MS, IMS, iDMA, FAIMS or GC) connected thereto.

In a further aspect, the invention provides a combination of a device (VED) for extracting a vaporizable analyte from a sample gas containing the analyte and unwanted aerosol particle as defined herein and in any one of the foregoing aspects and embodiments, and an analytical instrument (such as MS, IMS, iDMA, FAIMS or GC) connected thereto via an aerosol formation killer device.

In particular embodiments of the invention, there are provided:

(a) a device as defined in any one of the foregoing aspects and embodiments which is a miniature VED device designed with D<5 mm and L<50 mm to be connected to a handheld IMS to increase sensitivity of detection and reduce damage by the particulate matter of the IMS instrument;

(b) a device as defined in any one of the foregoing aspects and embodiments which is a VED of an axial symmetry design and which is connected to a portable IMS to increase sensitivity of detection and reduce damage by the particulate matter of the IMS instrument;

(c) a device as defined in any one of the foregoing aspects and embodiments which is a miniature VED designed with D<6 mm and L<80 mm to be connected to a handheld MS to increase sensitivity of detection and reduce damage by the particulate matter of the MS instrument;

(d) a device as defined in any one of the foregoing aspects and embodiments which is a VED of an axial symmetry design with D<6 mm and L<290 mm is connected to a portable MS to increase sensitivity of detection and reduce damage by the particulate matter of the IMS instrument;

(e) a device as defined in any one of the foregoing aspects and embodiments which is a miniature VED device designed with D<5 mm and L<360 mm to be connected to a handheld GC to increase sensitivity of detection and reduce damage by the particulate matter of the GC instrument; and

(f) a device as defined in any one of the foregoing aspects and embodiments which is of an axial symmetry design with D<6 mm and L<110 mm to be connected to a portable/stationary GC to increase sensitivity of detection and reduce damage by the particulate matter of the GC instrument.

It also should be understood that a plurality of VEDs can be connected in parallel or in series. One advantage of using multiple VEDs is selectivity of vapour extraction. For example, if two VEDs are connected in series such that the waste flow of the first VED is directed to the sample inlet of the second VED, and if Tₕ of the first VED is lower than Tₕ for the second VED, then it is possible to extract all VOCs in the first VED and use the waste outlet of the first VED without VOCs as a sample flow for the second VED where SVOSs are extracted and can be analysed by an instrument such as an IMS or other instrument as hereinbefore defined. This will reduce background noise in the analytical results (e.g. IMS spectra) and improve both sensitivity and the resolution of the analytical instrument (e.g. IMS). This can be especially advantageous in challenging environments with high levels of air contamination.

Accordingly, in a further aspect, the invention provides a combination comprising a plurality of VEDs as defined herein connected in parallel or in series, wherein an aerosol formation killer device is optionally connected to a second outlet of any one or more of the plurality of VEDs.

In another aspect, the invention provides a method for extracting a vaporizable analyte from a sample gas containing the analyte and unwanted aerosol particles; which method comprises passing the sample gas through a device comprising a vapour extraction chamber, first and second inlets, and first and second outlets;
the vapour extraction chamber being provided with or being linked to a heat source which heats the vapour extraction chamber to a desired temperature to facilitate vaporization of analyte present in the sample gas;
the first and second inlets being linked to an upstream end of the vapour extraction chamber and the first and second outlets being linked to a downstream end of the extraction chamber;
the first inlet allowing a sample of gas containing the analyte and unwanted aerosol particles to be introduced into the vapour extraction chamber;
the second inlet being connected to a clean gas supply that does not contain the analyte or unwanted aerosol particles;
such that a sample gas flow is established through the vapour extraction chamber between the first inlet and the first outlet, and a clean gas flow is established through the vapour extraction chamber between the second inlet and the second outlet; whereby analyte in vapour form present in the sample gas flow diffuses into the clean gas flow;
whereby waste sample gas passes out of the first outlet, and the clean gas flow containing analyte that has diffused into the clean gas flow passes out of the second outlet and is directed to an instrument for analysing the analyte.

The device used to perform the foregoing method is typically a device as defined in any one of the foregoing aspects and embodiments of the invention or as described in the specific description and examples below.

The sample gas flow and clean gas flow are preferably laminar flows, and hence there is no significant turbulence and no significant mixing of the two flows. Laminar flows can be defined with respect to their Reynolds numbers (Re), a Reynolds number of less than 2300 denoting substantially laminar flow. Thus, the device of the invention is typically configured and used such that the gas flow therethrough is characterised by a Reynolds number of less than 2300. Preferably the Reynolds number (Re) is <2,000 and more preferably the Reynolds number (Re) is less than 1,700. A consequence of laminar flow is that movement of the vaporized analyte from the sample gas flow to the clean gas flow is a result of diffusion rather than significant mixing of the two gas flows.

The two gas flows may be side-by-side, or one gas flow may form a sheath around the other gas flow. For example, in one embodiment, the clean gas flow forms a sheath around the sample gas flow. In another embodiment, the sample gas flow forms a sheath around the clean gas flow.

In the method of the invention, the temperature (Tₕ) inside the vapour extraction chamber may be selected so as to bring about selective or preferential vaporization of one or more analytes of interest. The method of the invention may thus be “tuned” for selective or preferential extraction of specific analytes.

The method of the invention is typically a real-time method of analysis in that gas (e.g. air) samples can be taken and analysed and the results of the analysis provided without significant delay following the collection of the sample gas.

It will be appreciated from the foregoing that, in a further aspect, the invention provides a method for a real-time extraction of volatile and semi-volatile analyte compounds from an aerosol sample gas flow that comprises:
passing the aerosol sample gas flow through a heated vapour extraction chamber.
establishing at least two (preferably laminar or low turbulence) flows through the vapour extraction chamber: (i) an aerosol sample gas flow containing aerosol particles and (ii) a clean gas (e.g. air) flow (without particulate matter), and joining the two flows together in a laminar regime to form a single non-uniform flow at an inlet to the vapour extraction chamber, whereby the single non-uniform flow contains two adjacent sections moving in parallel: the aerosol sample gas flow section and the clean gas flow section,
heating the non-uniform flow containing two adjacent sections (aerosol sample and clean gas flow sections) to evaporate volatile and semi-volatile analyte compounds from the aerosol sample gas flow section into the clean gas flow section.
whereby, when evaporation of the volatile and semi-volatile analyte compounds is substantially complete, the single non-uniform flow is split into two flows in such a way that the clean gas flow section of the joint flow containing volatile and semi-volatile compound vapours is directed to one outlet for analysis with a vapour measuring instrument, and the aerosol sample gas flow section of the joint flow containing non-volatile residuals of the aerosol sample gas flow directed to a waste outlet.

### BRIEF DESCRIPTION OF THE DRAWINGS

FIG. 1 is a schematic longitudinal sectional view of a VED according to a first embodiment of the invention.

FIG. 2 is a schematic view of the VED of FIG. 1 but with an aerosol HEPA filter connected in-line with the waste outlet.

FIG. 3 is a schematic view of the VED of FIG. 1 set up to clean and recycle waste sample gas which is then re-used as a clean gas flow.

FIG. 4 is a schematic longitudinal sectional view of a VED according to an embodiment of the invention which has axial symmetry.

FIG. 5 is a plot of the VED temperature against the concentration of analyte (expressed as a percentage) in the vapour outlet compared to the concentration in the waste outlet obtained from a VED having an axial symmetry geometry. The sample gas flow rate was 0.135 l/min; the vapour extraction flow rate was—0.2 l/min; and the waste flow rate—0.16 l/min.

### DETAILED DESCRIPTION OF THE INVENTION

The invention will now be illustrated, but not limited, by reference to the specific embodiments shown in the drawings and described below.

In the specific embodiments below, the operation of the devices may be discussed with reference to air flows (e.g. sample air flow and clean air flow) through the device but it will be understood that other gases may be substituted for air.

FIG. 1 illustrates a real-time VED device 1 according to a first embodiment of the invention. The VED device comprises a vapour extraction chamber 2 which can be heated (heating element not shown) to maintain an elevated temperature at a predefined level. The vapour extraction chamber 2 has two inlets 3 and 4 and two outlets 5 and 6.

Inlet 3 (the “first inlet”) is connected by inlet conduit 3c (the “first inlet conduit”) to the upstream end of the vapour extraction chamber 2. Inlet 4 (the “second inlet”) is connected to the upstream end of the vapour extraction chamber 2 by inlet conduit 4c (the “second inlet conduit”).

Outlet 5 (the “first outlet”) is connected by outlet conduit 5c (the “first outlet conduit”) to the downstream end of the vapour extraction chamber. Outlet 6 (the “second outlet”) is connected by outlet conduit 6c (the “second outlet conduit”) to the downstream end of the vapour extraction chamber 2.

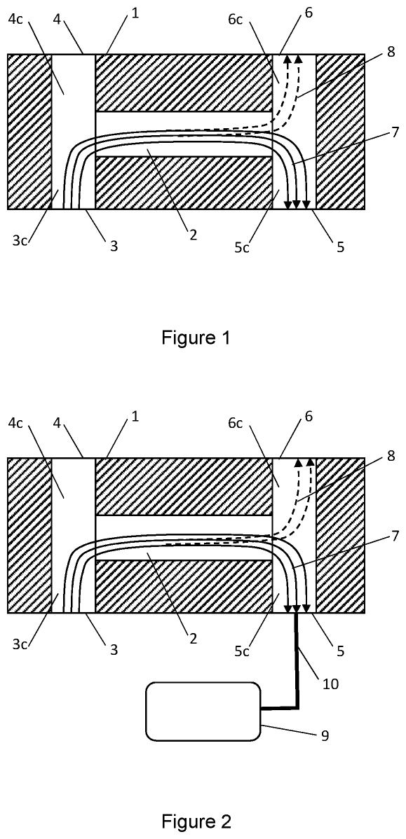

In use, the vapour extraction chamber is heated to a desired temperature in order facilitate evaporation of analyte compounds of interest. A sample of air (or another sample gas) containing aerosol particles and vapour is introduced through the first inlet 3 into the conduit 3c. A stream of clean air (or another clean gas) without aerosol particles is introduced through the second inlet 4 into the conduit 4c. At the upstream entrance to the vapour extraction chamber 2, the sample air flow coming from the conduit 3c and the clean air flow coming through conduit 4c are joined together to form a non-uniform (but preferably laminar) joint flow containing a sample flow section and a clean air section where the two air masses move in parallel and in close proximity. During their passage through the vapour extraction chamber, volatile analyte compounds in the sample flow section that enter the chamber 2 in the form of particles 7 are vaporized and at least a proportion of the vaporized analyte compounds diffuse into the clean air section 8 of the joint flow. Non-volatile residual particles 7 are carried out to the waste flow outlet 5 via the conduit 5c and are either released directly into the atmosphere or (more preferably) are first passed through a high capacity HEPA filter 9 (see FIG. 2) before released into the atmosphere.

The clean air section 8 of the joint flow containing volatile analyte compounds that have diffused from the sample air-flow section passes along the conduit 6c to the second outlet 6 from which it is directed to an instrument (e.g. an IMS) that analyses analyte compounds of interest.

In this way the vapour is extracted from aerosol particles in the sample flow and the vaporized analytes can then to be analysed with a vapour quantifying analytical instrument. At the same time, non-volatile residual particles 7 are released through the waste outlet 5. Thus, non-volatile residual particles do not pass into the analytical instrument to any significant extent and therefore damage to the instrument that might otherwise have been caused by such particles is avoided.

A further advantage of the device of the invention is that there is no heated in-line filter that can eventually become clogged. A high-capacity HEPA filter, if used in the waste flow, requires a long time to be completely clogged and, in any event, the extent of loading of the filter does not affect the performance of the VED because analytes do not enter the waste flow to any significant extent.

A first important factor governing the performance of the VED device of the invention is the flow regime. This factor can be referred to as a VED laminarity criterion. Thus, for efficient performance, the gas flow in the vapour extraction chamber should be substantially laminar to stop aerosol particles becoming entrained in the clean gas (e.g. air) flow. Typically, the Reynolds number (Re) is <2,300. Preferably the Reynolds number (Re) is <2,000 and more preferably the Reynolds number (Re) is less than 1,700.

The VED laminar criterion can be tested by measuring a fraction of the aerosol particles in the second outlet when the VED is not heated. Thus, it is important to maintain the non-uniformity of the gas flow, and the spatial separation of the two streams (aerosol laden stream and the initially clean air stream) forming the gas flow, along the length of the vapour extraction chamber 2.

The vapour extraction is based upon the difference in diffusion of aerosol particles and analytes. Diffusion coefficients of aerosol particles normally are many orders of magnitude lower than diffusion coefficients of analyte molecules.

This difference ensures that non-volatile residual particles 7 remain in the sample flow section of the non-uniform flow inside the chamber 2 and are carried out through the waste flow conduit 5c and the waste outlet 5. Because the extraction process involves diffusion from one gas stream to another, it is important to avoid turbulent mixing of the two gas streams.

The establishment of laminar flow and the avoidance of turbulent flow and mixing can be assisted by ensuring that the surfaces of the interior of the device that are in contact with the gas flows are as smooth as possible and that sharp edges and other formations that lead to turbulence are avoided. The manner in which this can be achieved will be readily apparent to the skilled person.

A second important factor influencing the performance of the VED is the length of the vapour extraction chamber 2. The length of chamber 2 should be great enough to enable vapour to be evaporated from aerosols efficiently. It should be noted that the efficiency of evaporation is influenced by the temperature of the chamber Tₕ. For a given analyte, the minimum necessary length of the chamber and the optimal heating temperature Tₕ can be determined empirically by trial and error experimentation.

A further factor influencing the performance of the VED can be defined as the buoyancy restriction or buoyancy criterion. Inside the vapour extraction chamber 2 the central section is cooler than the section near the internal surface wall bounding the chamber. This temperature difference generates convection flows due to expansion of the gas when the temperature is increasing. In order to prevent buoyancy arising from the temperature difference from causing mixing of the two sections of the non-uniform flow in chamber 2, a restriction may be placed on the maximal diameter D of the vapour extracting chamber 2.

An example of the VED buoyancy criterion (which is an indicative criterion) is D <0.5*(Qₛₐₘₚₗₑ+Q_{clean})*(Tₐ/Tₕ). For each geometry and operation regime, the minimum diameter of the chamber and the optimal heating temperature Tₕ can be determined empirically by trial and error experimentation.

FIG. 2 illustrates a VED of the type shown in FIG. 1 but wherein an aerosol filter 9 is connected by tubing 10 to the waste flow outlet 5 to reduce contamination of the environment with particulate matter in the sample gas flow. The aerosol filter can be a HEPA filter or any other filter of sufficient capacity.

FIG. 3 shows an arrangement in which the waste gas flow 7 is cleaned and recycled to be used as the clean gas (e.g. air) supply. The waste flow 7 containing non-volatile residual particles is directed through the outlet 5 to the first aerosol filter 9 via tubing 10. A pump 11 directs the flow of filtered air to the second filter 12 and finally to an activated black carbon filter 13. In this arrangement, the waste flow initially is cleaned with the first filter 9 that removes residual non-volatile particles from the flow, the second filter 12 removes particles that might be generated by the pump 11 and finally the activated black carbon filter 13 removes traces of analytes from the waste flow. The cleaned air flow the enters the clean air inlet 4. A valve 14 attached to a bleed line (shown with an arrow) is provided so that adjustments to the flow rates of air being recycled can be made and removal of the non-volatile residual aerosol particles can be optimised. The optimal flow rates can be determined by trial and error.

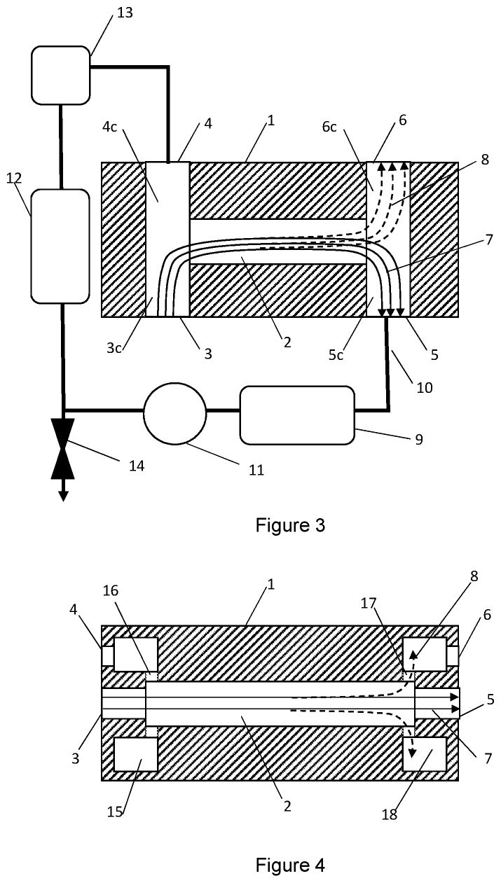

FIG. 4 illustrates a VED according to another embodiment of the invention. In this embodiment, the VED has an axial symmetry.

In this embodiment, a sample air flow containing aerosol particles enters the first inlet 3 and passes along a short region (the “first inlet conduit”) of restricted width which opens out into the main body of the vapour extracting chamber 2. Non-volatile residual particles are carried straight along the chamber 2 with the waste air flow, through a further short region of restricted width (the “first outlet conduit”) at the downstream end of the chamber 2 to the waste flow outlet 5 (the “first outlet”).

The clean air flow enters the device through the clean air inlet (the “second inlet”) 4 and passes through the axial symmetry conduit 15 (the “second inlet conduit”) that has a circular slot 16 providing communication with the vapour extraction chamber and enabling the formation of an axially symmetrical flow of the clean air around the sample flow. The clean air flow and sample flow come together into a non-uniform axially symmetrical flow containing a sample flow 7 in the centre and a sheath of clean air flow around it. Provided that the two air flows are laminar according to the VED laminarity criterion, and there is no turbulence or convection mass transfer in the chamber 2, the aerosol particles 7 remain in the central section of the non-uniform flow, but volatile compounds evaporated from the particles move into the clean air flow 8 by Brownian diffusion. At the downstream end of the chamber 2, the non-uniform flow is split into two axially symmetrical flows: the central flow with non-volatile residual particles 7 and the clean air flow laden with vapour 8 that is directed through the circular slot 17 into the axial symmetry air conduit 18 (second outlet conduit) and finally to the vapour outlet 6 (second outlet) which is connected to an analytical instrument for analysing the analyte in the vapour-laden clean air flow. The splitting of the air flows at the downstream end of the chamber 2 prevents non-volatile residual particles entering the analytical instrument and damaging it. The VED shown in FIG. 4 is also a real-time device and provides rapid analysis of vaporizable analytes in air and other analytes with a device that operates preferably with vapour samples.

### EXAMPLES

A number of different designs of the VED device have been investigated, and tests have been carried out at temperatures varying from 20° C. to 300° C. and at flow rates of 0.1 l/min<{Qₛₐₘₚₗₑ, Q_{clean}, Q_{waste}, Qᵥₐₚₒᵤᵣ}<1.5 l/min. Several different types of geometries of VED were manufactured and tested. Two examples are described below.

### Example 1

An axial symmetry VED device similar to that shown in FIG. 4 has been manufactured from a stainless-steel cylinder of ID=5 mm and length L=120 mm. All the inlets and outlets were equipped with ¼′ Swage locks and copper tubing was used to connect the VED to the measuring instruments (e.g. an lonscan 400 instrument). The waste air flow leaving the VED chamber was cooled using coiled copper tubing 100 mm in length and filtered with two Mitsubishi aerosol filters connected to a SPF30 pump as shown in FIG. 3. The circular slot 16 was 1.5 mm wide and the axial symmetry conduits 15 were of 10 mm×10 mm cross-section.

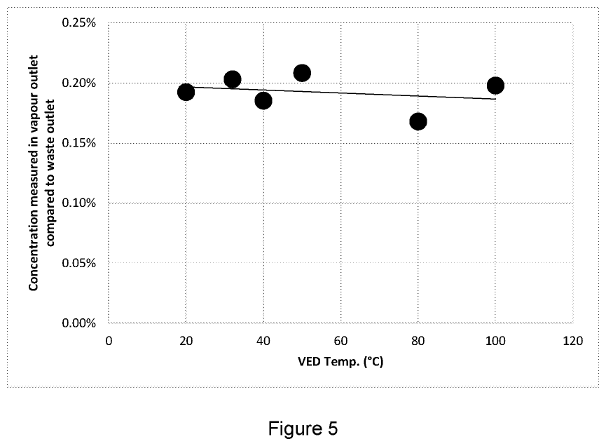

FIG. 5 shows the results of tests carried out to determine the distribution of non-volatile particles of tris(2-ethylhexyl) phosphate between the waste air flow and clean air flow. Thus, tris(2-ethylhexyl) phosphate with a particle number concentration of 1.2×10⁶ cm⁻³ was introduced into the sample inlet 3. This level of concentration is typical for a heavily polluted atmosphere. The efficiency of particle removal from the vapour outlet 6 was evaluated as the ratio of the number concentration of particles measured in the vapour outlet 6 to the number concentration of particles measured in the sample inlet 3 (see FIG. 4).

The results in FIG. 5 show that increasing the heater temperature of the VED (Tₕ) did not result in an increase in the number of particles reaching the vapour outlet. The percentage of particles reaching the vapour outlet remained very low (˜0.2%) throughout the temperature range from 20° C. to 100° C. Thus, the results show that, in a VED having the dimensions (e.g. extraction chamber ID) given in Example 1, the VED buoyancy criterion between the sample gas flow and clean gas flow was satisfied and the extent of mixing of the two gas flows was minimal.

The results demonstrate a considerable reduction in contamination of the vapour outlet by particles. Importantly the analyte (tris(2-ethylhexyl) phosphate) vapour concentration in the vapour outlet was 24 times greater than the vapour concentration in the sample flow. Therefore, the VED of the invention provides an improved sensitivity of analyte detection and prevents damage to analytical instruments by particulate matter in air samples.

### Example 2

Another example of an axial symmetry VED similar to that described in Example 1 was manufactured from a stainless-steel cylinder of ID=30 mm and a length L=120 mm. In Example 1, the ID was 5 mm. The other dimensions were as described in Example 1. For the larger ID, the number concentration of particles measured in the vapour outlet increased at the onset of heating to unacceptable levels close to 50% thereby demonstrating that mixing of the two gas streams can occur if the diameter of the VED is too great.

Using the template established by the specific embodiments and examples set out above, the optimal configuration (e.g. width and length) and the optimal operating conditions can readily be determined by routine trial and error.

It will be appreciated that numerous modifications and alterations can be made to the VED devices illustrated in the drawings and described in the specific examples above without departing from the principles of the invention as defined in the claims appended hereto.

1. A device for extracting a vaporizable analyte from a sample gas containing the analyte and unwanted aerosol particles;
the device comprising a vapour extraction chamber, first and second inlets, and first and second outlets;
the vapour extraction chamber being provided with or being linked to a heat source for heating the vapour extraction chamber to a desired temperature to facilitate vaporization of analyte present in the sample gas;
the first and second inlets being linked to an upstream end of the vapour extraction chamber and the first and second outlets being linked to a downstream end of the extraction chamber;
the first inlet allowing a sample of gas containing the analyte and unwanted aerosol particles to be introduced into the vapour extraction chamber;
the second inlet being connected or connectable to a clean gas supply that does not contain the analyte or unwanted aerosol particles;
the device being configured such that, in use, a sample gas flow is established through the vapour extraction chamber between the first inlet and the first outlet, and a clean gas flow is established through the vapour extraction chamber between the second inlet and the second outlet; whereby analyte in vapour form present in the sample gas flow diffuses into the clean gas flow, but the clean gas flow reaching the second outlet is substantially free of the said unwanted aerosol particles;
the first outlet serving as a waste outlet for the sample gas flow, and the second outlet being connected or connectable to an instrument for analysing analyte that has diffused into the clean gas flow.

2. A device according to claim 1 wherein the first outlet is provided with a particle filter to remove particles prior to release into the environment.

3. A device according to claim 1 wherein the first outlet is provided with a filter for removing any volatile compounds remaining in the sample gas stream as it passes to waste through the first outlet.

4. A device according to claim 2 wherein an activated black carbon filter is provided upstream or downstream of a particle filter.

5. A device according to claim 1 comprising a low pulsation clean flow maintaining system for supplying a clean gas flow Q_{clean} to the second inlet.

6. A device according to claim 1 comprising a flow maintaining system that enables low pulsation gas flows to be generated with ΔQi/Qi<7%, where ΔQi is the average magnitude of pulsations in flow rates through each of the first and second inlets and the first and second outlets.

7. A device according to claim 1 wherein the vapour extraction chamber, inlets, outlets and any associated conduits, if present, are configured so as to maintain laminar flow of the sample gas flow and the clean gas flow though the device so that unwanted aerosol particles are preferably directed to the first outlet.

8. A device according to claim 1 which is configured such that sample gas flow and clean gas flow through the device is characterised by a Reynolds number (Re) of <2,300.

9. A device according to claim 1 which is provided with a heat source that can be operated heat the vapour extraction chamber to a temperature Tₕ of up to 700° C.

10. A device according to claim 1 wherein the vapour extraction chamber is cylindrical in shape.

11. A device according to claim 1 wherein the vapour extracting chamber has a length greater than a length, in centimetres, defined by a non-equality:
L>1.2*(Qₛₐₘₚₗₑ+Q_{clean})*(Tₐ/Tₕ)
where Qₛₐₘₚₗₑ and Q_{clean} are the gas flow rates of the sample gas flow and clean gas flow respectively, Tₐ is the ambient temperature, Tₕ is the temperature in the vapour extraction chamber, wherein both Tₐ and Tₕ are in degrees K and the flow rates are in cm³/s.

12. A device according to claim 1 wherein the vapour extraction chamber has an internal diameter D, in centimetres, defined by a non-equality:
D<0.5*(Qₛₐₘₚₗₑ+Q_{clean})*(Tₐ/Tₕ)
where Qₛₐₘₚₗₑ and Q_{clean} are the gas flow rates of the sample gas flow and clean gas flow respectively, Tₐ is the ambient temperature, Tₕ is the temperature in the vapour extraction chamber, wherein both Tₐ and Tₕ are in degrees K and the flow rates are in cm³/s.

13. A device according to claim 1 wherein the first outlet is connected to a heat exchanger to reduce the temperature of the waste gas emerging from the waste outlet, and optionally wherein the heat exchanger is linked at a downstream end thereof to an aerosol filter.

14. A device according to claim 1 wherein the first outlet is linked via one or more purification elements to the clean gas supply inlet thereby enabling recycling of the waste gas flow to take place.

15. A combination of a device for extracting a vaporizable analyte from a sample gas containing the analyte and unwanted aerosol particle as defined in claim 1, and an analytical instrument connected thereto.

16. A combination of a device for extracting a vaporizable analyte from a sample gas containing the analyte and unwanted aerosol particle as defined in claim 1 and an analytical instrument connected thereto via an aerosol formation killer device.

17. A combination comprising a plurality of devices as defined in claim 1 connected in parallel or in series, wherein an aerosol formation killer device is connected to a second outlet of any one or more of the plurality of devices.

18. A combination according to claim 16 wherein:
(a) the device is a miniature VED device having a vapour extraction chamber of internal diameter D<5 mm and a length L<50 mm which is connected to a handheld IMS; or
(b) the device is a VED of an axial symmetry design which is connected to a portable IMS; or
(c) the device is a miniature VED having a vapour extraction chamber of internal diameter D<6 mm and a length L<80 mm which is connected to a handheld MS; or
(d) the device is a VED of an axial symmetry design having a vapour extraction chamber of internal diameter D<6 mm and length L<290 mm which is connected to a portable MS; or
(e) the device is a miniature VED device having a vapour extraction chamber of internal diameter D<5 mm and length L<360 mm which is connected to a handheld GC; or
(f) the device is an axial symmetry design having a vapour extraction chamber of inner diameter D<6 mm and length L<110 mm which is connected to a portable/stationary GC.

19. A method for extracting a vaporizable analyte from a sample gas containing the analyte and unwanted aerosol particles; which method comprises passing the sample gas through a device comprising a vapour extraction chamber, first and second inlets, and first and second outlets;
the vapour extraction chamber being provided with or being linked to a heat source which heats the vapour extraction chamber to a desired temperature to facilitate vapourisation of analyte present in the sample gas;
the first and second inlets being linked to an upstream end of the vapour extraction chamber and the first and second outlets being linked to a downstream end of the extraction chamber;
the first inlet allowing a sample of gas containing the analyte and unwanted aerosol particles to be introduced into the vapour extraction chamber;
the second inlet being connected to a clean gas supply that does not contain the analyte or unwanted aerosol particles;
such that a sample gas flow is established through the vapour extraction chamber between the first inlet and the first outlet, and a clean gas flow is established through the vapour extraction chamber between the second inlet and the second outlet; whereby analyte in vapour form present in the sample gas flow diffuses into the clean gas flow;
whereby waste sample gas passes out of the first outlet, and the clean gas flow containing analyte that has diffused into the clean gas flow passes out of the second outlet and is directed to an instrument for analysing the analyte, but wherein the clean gas flow passing out through the second outlet is substantially free of the said unwanted aerosol particles, said unwanted aerosol particles instead remaining predominantly in the sample gas flow and being directed to the first outlet.

20. A method according to claim 19 wherein the device is as defined in claim 1.
